(19) United States
(12) Patent Application Publication
(10) Pub. No.: US 2007/0136755 A1
(43) Pub. Date: Jun. 14, 2007

(54) Video content viewing support system and method

(76) Inventor: Tetsuya Sakai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/604,363

(22) Filed: Nov. 27, 2006

(30) Foreign Application Priority Data
Nov. 28, 2005 (JP) 2005-342337

(51) Int. Cl. H04N 7/10; H04N 7/025; H04N 5/91; H04N 5/445; G06F 3/00; H04N 7/00; G06F 13/00

(52) U.S. Cl. 725/46; 725/45; 386/46; 725/44; 725/34; 725/35

(57) ABSTRACT

A video content viewing support system includes unit acquiring video content and text data corresponding to the video content, unit extracting viewpoints from the video content, based on the text data, unit extracting, from the video content, topics corresponding to the viewpoints, based on the text data, unit dividing the video content into content segments including first segments and second segments for each of the extracted topics, the first segments corresponding to a first viewpoint included in the viewpoints, the second segments corresponding to a second viewpoint included in the viewpoints, unit generating a thumbnail and a keyword for each of the content segments, unit providing the first segments and at least one of the thumbnail and the keyword corresponding to one of the first segments for each of the first segments, and unit selecting at least one of the provided first segments.

### CROSS-REFERENCE TO RELATED APPLICATIONS

This application is based upon and claims the benefit of priority from prior Japanese Patent Application No. 2005-342337, filed Nov. 28, 2005, the entire contents of which are incorporated herein by reference.

### BACKGROUND OF THE INVENTION

1. Field of the Invention

The present invention relates to a video content viewing support system capable of providing a user with video content divided in units of topics, and enabling efficient viewing of the video content, and also to a video content viewing support method for use in the system.

2. Description of the Related Art

At present, the audience can access various types of video content, such as TV programs, broadcast by, for example, terrestrial, satellite or cable broadcasting, and also can access movies distributed by various media, such as DVDs. It is expected that the amount of viewable content will go on increasing in accordance with an increase in the number of channels and spread of cost-effective media. Therefore, it is possible that selective viewing, in which at first, the entire structure, e.g., table, of a single piece of video content is skimmed, and then only the interesting portion is selected and viewed, may become prevailing in place of a conventional fashion of viewing in which one piece of video content is viewed from the beginning to the end.

For instance, if two or three particular topics are selected from a two-hour information program containing unorganized topics, and viewed, the total required time is only several tens of minutes, and the remaining time can be used for viewing other programs or for matters other than video content viewing, with the result that an efficient lifestyle can be established.

To realize selective viewing of video content, a user interface may be provided for a viewer (see, for example, JP-A 2004-23799(KOKAI)). The user interface displays a key frame, i.e., a thumbnail image, in units of divided video content items, and displays information indicating the degree of interest of a user, together with each thumbnail image.

In the above-described conventional method, it is assumed that an appropriate division method for video content is uniquely determined. Specifically, if a certain news program contains five items of news, it is assumed that this program is divided into five sections corresponding to the respective news items. In general, however, it is possible that the way of extraction of topics from video content differs depending upon the interests of users or categories of the video content. Namely, the way of the extraction is not always uniquely determined. For instance, in the case of a TV program related to a trip, a certain user may want to view the portion of the program in which a particular performer they like appears. In this case, it is desirable to provide a video content segmentation result based on the changes of performers.

Another user who is viewing the same program may not be interested in a particular performer but be interested in a certain destination of the trip. In this case, it is desirable to provide a video content segmentation result based on the changes of the names of places, hotels, etc. Further, in the case of a TV program related to, for example, animals, if a video content segmentation result based on the changes of the names of animals, and the program contains parts related to monkeys, dogs and birds, the user can select and view only, for example, the dogs' part.

Similarly, in the case of a cooking program, if a segmentation result based on the changes of the names of dishes is provided as well as a segmentation result based on the changes of performers, the user can select, for example, the “part in which a performer A appears” and the “part in which the way of making a beef stew is demonstrated”.

As described above, in the prior art, only a single segmentation result can be provided for any video content, which means that it is difficult for users to select a desirable part. Furthermore, when a user provides feedback, such as “favorite”, “non-favorite”, concerning a certain segmentation result, it is difficult to perform appropriate personalization, since it is difficult to inform the system of the grounds (viewpoint) for the estimation, i.e., whether the estimation is based on the appearance of a particular performer or on the content related to a particular place. The personalization is a process, also called relevance feedback, for modifying the processing content of the system in accordance with the interests of users.

### BRIEF SUMMARY OF THE INVENTION

In accordance with an aspect of the invention, there is provided a video content viewing support system comprising: an acquisition unit configured to acquire video content and text data corresponding to the video content; a viewpoint extraction unit configured to extract a plurality of viewpoints from the video content, based on the text data; a topic extraction unit configured to extract, from the video content, a plurality of topics corresponding to the viewpoints, based on the text data; a division unit configured to divide the video content into a plurality of content segments including first segments and second segments for each of the extracted topics, the first segments corresponding to a first viewpoint included in the viewpoints, the second segments corresponding to a second viewpoint included in the viewpoints; a generation unit configured to generate a thumbnail and a keyword for each of the content segments; a providing unit configured to provide the first segments and at least one of the thumbnail and the keyword corresponding to one of the first segments for each of the first segments; and a selection unit configured to select at least one of the provided first segments.

In accordance with another aspect of the invention, there is provided a video content viewing support method comprising: acquiring video content and text data corresponding to the video content; extracting a plurality of viewpoints from the video content, based on the text data; extracting, from the video content, a plurality of topics corresponding to the viewpoints, based on the text data; dividing the video content into a plurality of content segments including first segments for each of the extracted topics, the first segments corresponding to a first viewpoint included in the viewpoints, the second segments corresponding to a second viewpoint included in the viewpoints; generating a thumbnail and a keyword for each of the content segments; providing the first segments and at least one of the thumbnail and the keyword corresponding to the one of the first segments for each of the first segments; and selecting at least one of the provided first segments.

### BRIEF DESCRIPTION OF THE SEVERAL VIEWS OF THE DRAWING

FIG. 1 is a block diagram illustrating a video content viewing support system according to a first embodiment;

FIG. 2 is a flowchart illustrating the process of the viewpoint determination unit appearing in FIG. 1;

FIG. 3 is a view illustrating a unique expression extraction result acquired at step S203 in FIG. 2;

FIG. 4 is a flowchart illustrating the process of the topic division unit appearing in FIG. 1;

FIG. 5 is a flowchart illustrating the process of the topic list generation unit appearing in FIG. 1;

FIG. 6 is a view illustrating topic list information provided by the output unit appearing in FIG. 1;

FIG. 7 is a flowchart illustrating the process of the replay portion selection unit appearing in FIG. 1;

FIG. 8 is a block diagram illustrating a video content viewing support system according to a second embodiment; and

FIG. 9 is a view illustrating topic list information provided by the output unit appearing in FIG. 8.

### DETAILED DESCRIPTION OF THE INVENTION

Video content viewing support systems and methods according to embodiments of the invention will be descried in detail with reference to the accompanying drawings.

The video content viewing support systems and methods of embodiments enable efficient viewing of given video content based on the viewpoints of users.

### First Embodiment

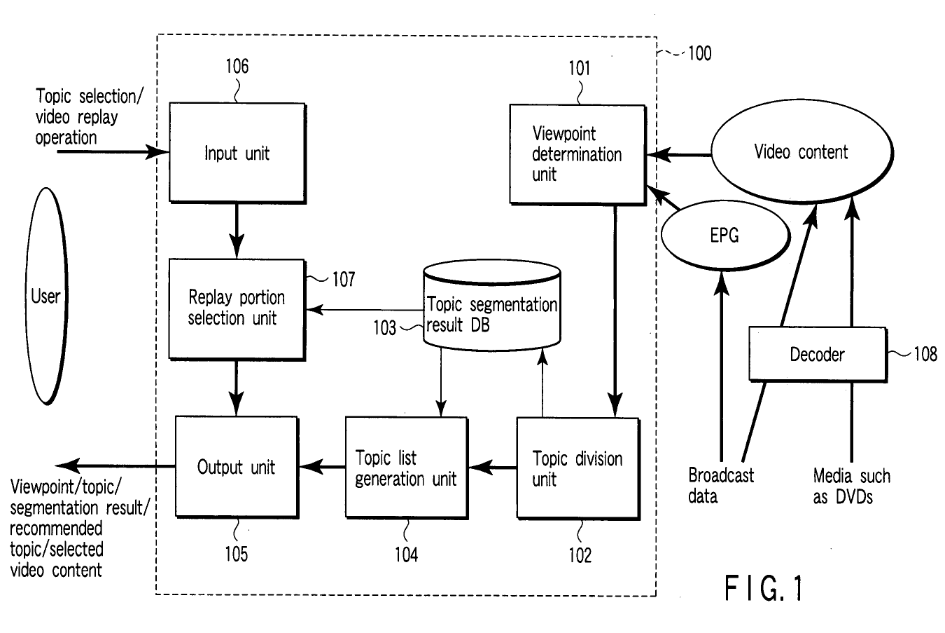

Referring first to FIG. 1, a video content viewing support system and method according to a first embodiment will be described. FIG. 1 is a schematic block diagram illustrating the video content viewing support system of the first embodiment.

As shown, the video content viewing support system 100 of the first embodiment comprises a viewpoint determination unit 101, topic division unit 102, topic segmentation result database (DB) 103, topic list generation unit 104, output unit 105, input unit 106 and replay portion selection unit 107.

The viewpoint determination unit 101 determines at least one viewpoint for performing topic division on video content.

The topic division unit 102 divides video content into topics based on respective viewpoints.

The topic segmentation result database 103 stores the result of topic division performed by the topic division unit 102.

The topic list generation unit 104 generates, based on the topic segmentation result, thumbnails and keywords to be provided for a user in the form of topic list information.

The output unit 105 provides the user with topic list information and video content. The output unit 105 has, for example, a display screen.

The input unit 106 is, for example, a remote controller or keyboard, which accepts operation commands issued by the user, such as a command to select a topic, and a command to start, end or fast-forward the replay of video content.

The replay portion selection unit 107 generates video information to be provided for the user in accordance with the topic selected by the user.

The operation of the video content viewing support system of FIG. 1 will be described.

Firstly, the viewpoint determination unit 101 acquires video content output from an external device, such as a television set, DVD player/recorder or hard disk recorder, and decoded by a decoder 108. Based on the acquired video content, the viewpoint determination unit 101 determines a plurality of viewpoints. If the video content is broadcast data, electronic program guide (EPG) information related to the video content may be acquired simultaneously. The EPG information contains text data indicating the outline or category of each program provided by broadcast stations, and performers appearing in each program.

The topic division unit 102 divides the video content into topics based on the viewpoints determined by the viewpoint determination unit 101, and stores the segmentation result in the topic segmentation result database 103.

Many video content items contain text data, called closed captions, which can be extracted by a decoder. In this case, for topic division of the video content, a known topic division method for text data can be utilized. For instance, “Hearst, M. TextTiling: Something Text into Multi-Paragraph Subtopic Passages, Computational Linguistics, 23(1), pp. 33-64, Mar. 1997. http://acl.ldc.upenn.edu/J/J97/J97-1003.pdf” discloses a method for comparing terms included in text data and automatically detecting the switching point of topics.

Further, in the case of video content that contains no closed captions, an automatic speech recognition technique may be applied to audio data in the video content to acquire text data used for topic division, as is disclosed in “Smeaton, A., W. and Over, P.: The TREC Video Retrieval Evaluation (TRECVID): A Case Study and Status Report, RIAO 2004 conference proceedings, 2004. http://www.riao.org/Proceedings-2004/papers/0030.pdf.”

Subsequently, the topic list generation unit 104 generates a thumbnail and/or keyword(s) corresponding to each topic segment included in each topic, based on the topic segmentation result stored in the topic segmentation result database 103, and provides it to the user via the output unit 105, such as a TV screen. From the topic segments contained in the provided topic segmentation result, the user selects the one they want to view, using the input unit 106, such as a remote controller or keyboard.

Lastly, the replay portion selection unit 107 refers to the topic segmentation result database 103 to generate video information to be provided for the user, based on the selected information output from the input unit 106.

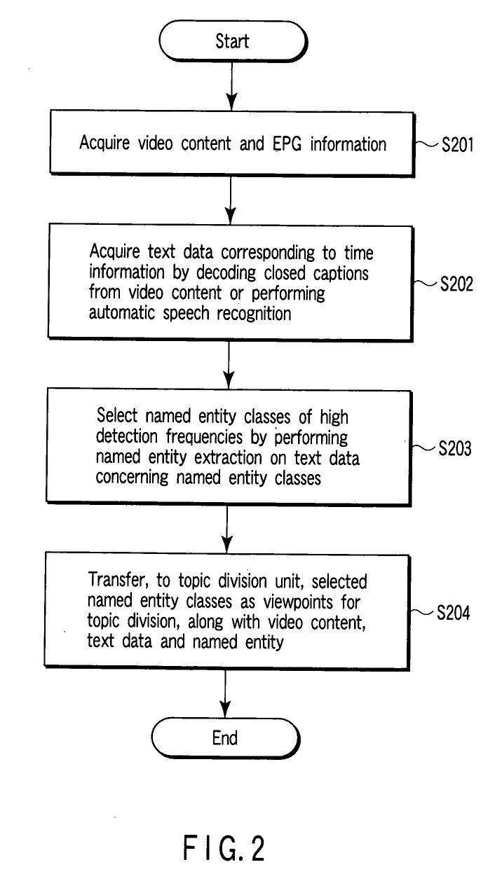

Referring to the flowchart of FIG. 2, the process performed by the viewpoint determination unit 101 of FIG. 1 will be described.

Firstly, video content is acquired from a television set, DVD player/recorder or hard disk recorder, etc. (step S201). If the video content is broadcast data, the EPG information corresponding to the video content may be acquired simultaneously.

The text data corresponding to time information contained in the video content is generated by decoding the closed captions in the video content or performing automatic speech recognition on the audio data in the video content (step S202). A description will now be given the case where the text data is mainly formed of closed captions.

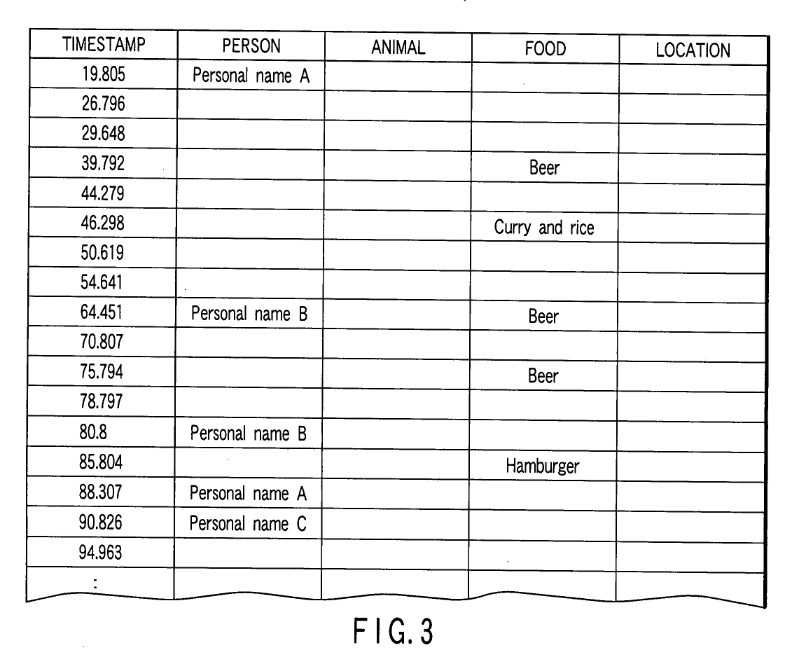

Information (named entity classes) indicating personal names, food names, animal names and/or place names is extracted from the text data generated at step S202, using named entity recognition, and named entity classes of higher detection frequencies are selected (step S203). The results acquired at step S203 will be described later with reference to FIG. 3.

A named entity recognition technique is disclosed in, for example, “Zhou, G. and Su, J.: Named Entity Recognition using an HMM-based Chunk Tagger, ACL 2002 Proceedings, pp. 473-480, 2004. http://acl.ldc.upenn.edu/P/P02/P02-1060.pdf.”

The named entity classes selected at step S203, video data, and the text data generated or the closed captions decoded at step S202 are transferred to the topic division unit 102 (step S204).

Referring to FIG. 3, a description will be given of an example of a result obtained by performing named entity extraction processing on the closed captions related to the time information. FIG. 3 shows the named entity extraction result obtained at step S203.

In FIG. 3, TIMESTAMP indicates the time (seconds) elapsing from the start of video content. In the shown example, named entity extraction is performed on four named entity classes, such as PERSON (personal names), ANIMAL (animal names), FOOD (food names) and LOCATION (place names), with the result that the “Personal name A” of a performer, for example, is extracted as PERSON, and “Curry and rice” and “Hamburger”, etc., are extracted. On the other hand, no character strings corresponding to ANIMAL or LOCATION are extracted.

Thus, when the detected closed captions are subjected to named entity extraction based on a plurality of named entity classes beforehand prepared, many elements are extracted concerning some named entity classes, and a few elements are extracted concerning other entity classes.

Based on the extraction result of FIG. 3, the viewpoint determination unit 101 determines to employ, as viewpoints for topic division, named entity classes PERSON and FOOD detected with high frequencies, for example. The viewpoint determination unit 101 transfers, to the topic division unit 102, the viewpoint information, video data, closed captions and named entity extraction result.

When named entity extraction is performed on a cooking program, a biased extraction result, in which, for example, only personal names and food names are contained, may be acquired as shown in FIG. 3. Further, when named entity extraction is performed on a program concerning pets, a biased extraction result, in which the ratio of personal names and animal names to other names is too high, may be acquired. Similarly, when named entity extraction is performed on a TV travel program, a biased extraction result, in which the ratio of personal names and place names to other names is too high, may be acquired. Thus, in the embodiment, the viewpoint for topic division can be changed in accordance with video content. Further, a segmentation result based on a plurality of viewpoints can be provided for users, as well as a segmentation result based on a single viewpoint.

The process of FIG. 2 performed by the viewpoint determination unit 101 can be modified such that a viewpoint is determined from category information or program content recited in EPG information, instead of performing named entity extraction on closed captions. In this case, it is sufficient if a determination rule is prepared beforehand, in which when the category is a cooking program, or the program content contains a term “cooking”, the viewpoint is set to PERSON and FOOD, while when the category is an animal program, or the program content contains a term “animal”, “dog” or “cat”, etc., the viewpoint is set to PERSON and ANIMAL.

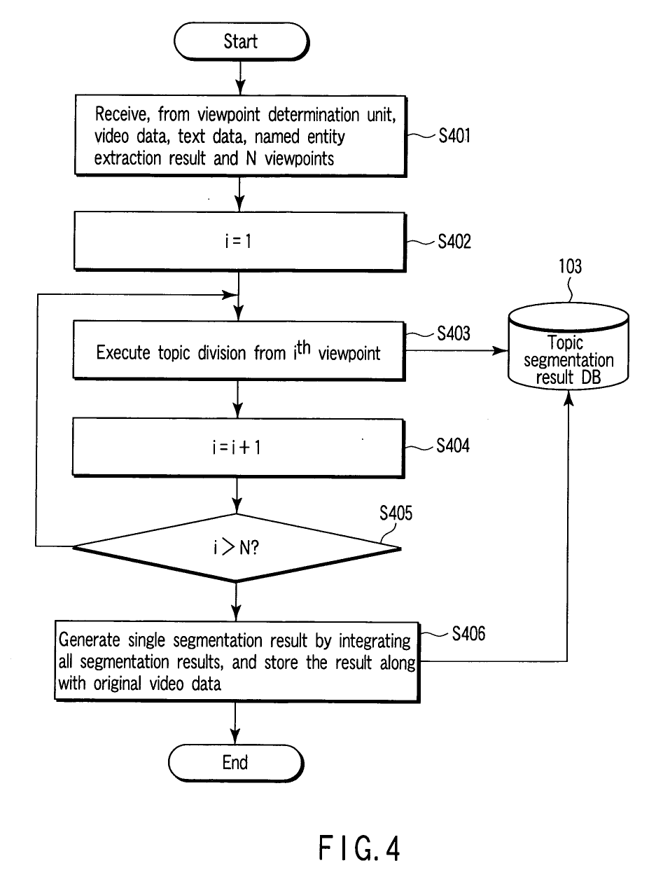

Referring to FIG. 4, the process of the topic division unit 102 of FIG. 1 will be described. FIG. 4 is a flowchart illustrating a process example performed by the topic division unit 102 in the first embodiment.

Firstly, the topic division unit 102 receives, from the viewpoint determination unit 101, video data, closed captions, such a named entity extraction result as shown in FIG. 3, and N viewpoints (step S401). For instance, where PERSON and FOOD are selected as viewpoints as described above, N=2.

Subsequently, topic division processing is performed for each viewpoint, and the segmentation result is stored in the topic segmentation result database 103 (steps S402 to S405). For topic division, various techniques can be utilized, which include TextTiling disclosed in “Hearst, M. TextTiling: Something Text into Multi-Paragraph Subtopic Passages, Computational Linguistics, 23(1), pp. 33-64, Mar. 1997. http://acl.ldc.upenn.edu/J/J97/J97-1003.pdf.” The simplest division method is, for example, a method of performing topic division whenever a new word appears in such a named entity extraction result as shown in FIG. 3. Specifically, when topic division is performed from the viewpoint of PERSON, it is performed 19.805 seconds, 64.451 seconds and 90.826 seconds after the start of video content, i.e., when the words “Personal name A”, “Personal name B” and “Personal name C” are detected, respectively.

The above-described process may be modified such that shot boundary detection is performed as the pre-process of topic division. Shot boundary detection is a technique for dividing video content based on a change in image frame, such as switching of scenes. Shot boundary detection is disclosed in, for example, “Smeaton, A., Kraaij, W. and Over, P.: The TREC Video Retrieval Evaluation (TRECVID): A Case Study and Status Report, RIAO 2004 conference proceedings, 2004. http://www.riao.org/Proceedings-2004/papers/0030.pdf.”

In this case, only the time point corresponding to each shot boundary is regarded as a time point candidate for topic division.

Lastly, the topic division unit 102 integrates topic segmentation results based on the respective viewpoints into a single topic segmentation result, and stores it along with the original video data (step S406).

In the integration, both the division sections based on the viewpoint of PERSON and those based on the viewpoint of FOOD may be employed, or only the overlapping sections of the division sections based on both the viewpoints of PERSON and FOOD may be employed.

Further, if a confidence score at each division point can be acquired, the integrated division points may be determined from, for example, the sum of the confidence scores. The first embodiment may also be modified such that no integration segmentation results are generated.

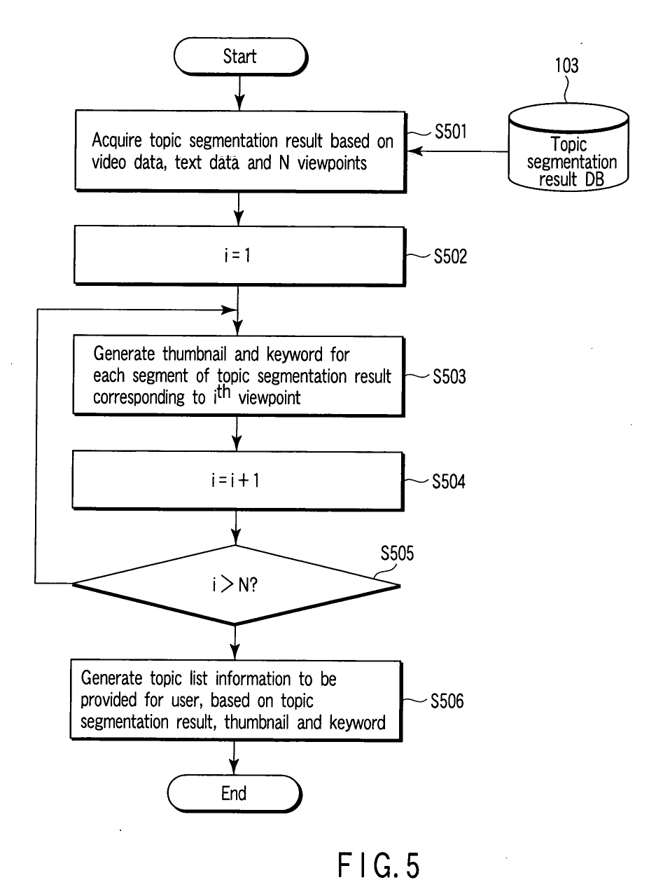

Referring to FIG. 5, the process of the topic list generation unit 104 shown in FIG. 1 will be described. FIG. 5 is a flowchart illustrating a process example performed by the topic list generation unit 104 in the first embodiment.

Firstly, the topic list generation unit 104 acquires, from the topic segmentation result database 103, a topic segmentation result based on certain video data, closed captions and viewpoints (step S501).

Subsequently, the topic list generation unit 104 generates a thumbnail and keyword(s) for each topic segment included in the topic segmentation result and corresponding to each viewpoint, using a known arbitrary technique (steps S502 to S505). In general, a thumbnail is generated by selecting, from the frame images of video data, the one corresponding to the start time of each topic segment, and contracting it. Further, a keyword (keywords) indicating the feature of each topic segment is selected by, for example, applying, to closed captions, a keyword selection method for relevance feedback performed during information search. Relevance feedback is also called personalization, and means a process for modifying the system processing content in accordance with interests of a user. It is disclosed in, for example, “Robertson, S. E. and Sparck Jones, K: Simple, proven approaches to text retrieval, University of Cambridge Computer Laboratory Technical Report TR-356, 1997. http://www.cl.cam.ac.uk/TechReports/UCAM-CL-TR-356.pdf.”

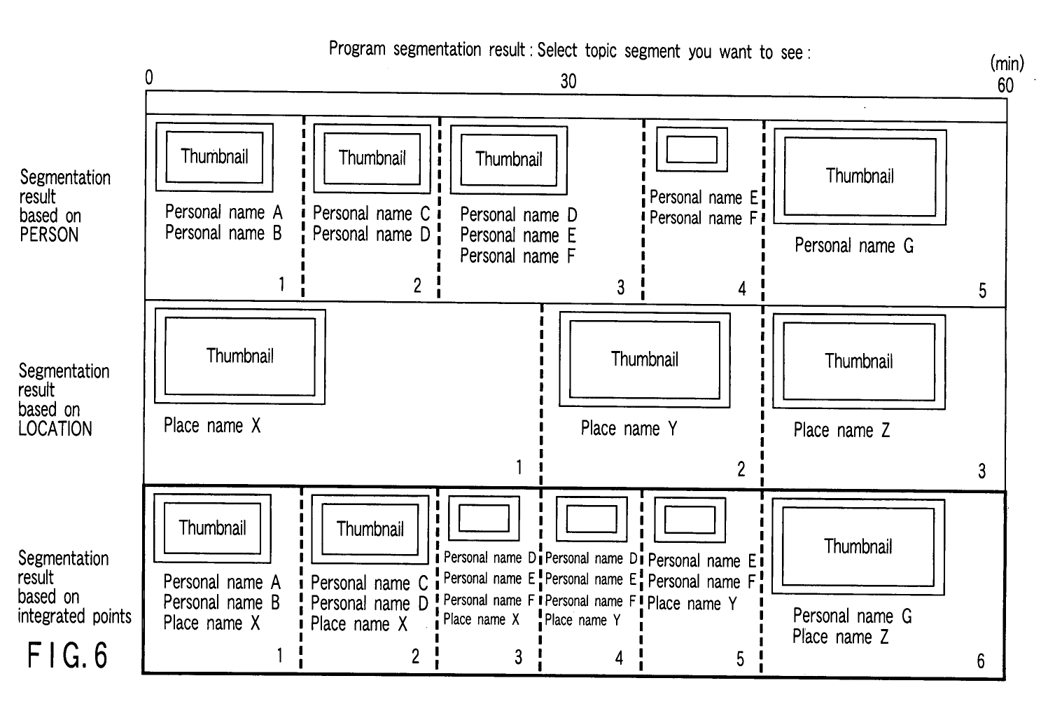

The topic list generation unit 104 generates topic list information to be provided for the user, based on the topic segmentation result, thumbnails and keywords, and outputs it to the output unit 105 (step S506). A topic list information example will be described referring to FIG. 6.

FIG. 6 shows a display example of the topic list information.

On the interface shown in FIG. 6 and provided by the output unit 105, the user selects the one or more thumbnails corresponding to one or more topic segments they want to view. Thus, the user can efficiently enjoy only the portion of a program that they want to view. In the example shown in FIG. 6, the user is provided with the results of topic division performed on a 60-minute travel program from two viewpoints “PERSON” and “LOCATION”, and with the result acquired by integrating the two topic segmentation results.

Each topic segment includes a thumbnail and keyword(s) indicating its feature. For instance, the segmentation result based on the viewpoint PERSON is formed of five topic segments, and the feature keywords of the first segment are “Personal name A” and “Personal name B”. From this segmentation result, the user can roughly grasp the change of performers in the TV travel program. If, for example, the user likes the performer with name D, they can select the second and third topic segments corresponding to the viewpoint PERSON.

Further, the topic segmentation result corresponding to the viewpoint LOCATION is acquired by performing topic division on the TV travel program, based on the names of hot springs or hotels. In this example, it is assumed that three hot springs are visited. If the user is not interested in the performers appearing in the program, but is interested in the second hot spring, they can view only the portion related to the second hot spring by selecting the second segment corresponding to the viewpoint LOCATION.

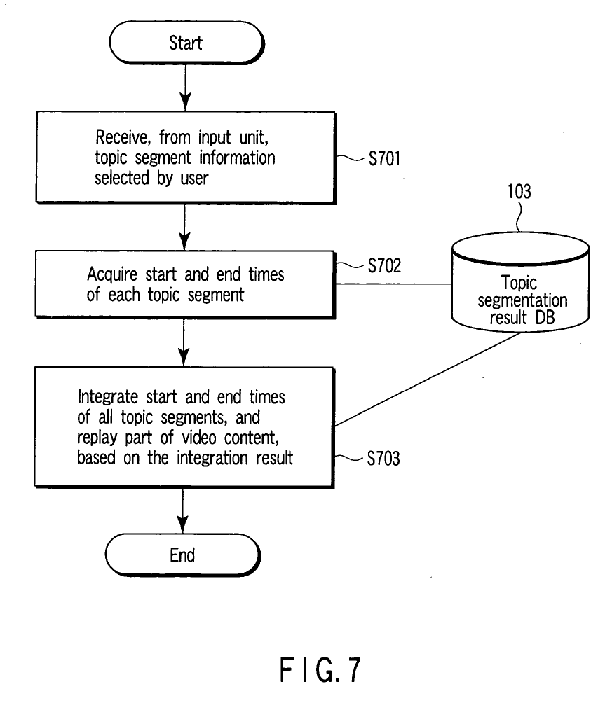

The user can select overlapping topic segments between different viewpoints. For instance, they can simultaneously select the second and third segments corresponding to the viewpoint PERSON, and the second segment corresponding to the viewpoint LOCATION. Although the third segment corresponding to the viewpoint PERSON temporally overlaps the second segment corresponding to the viewpoint LOCATION, it is easy to prevent the same content from being replayed twice. This process (i.e., the process of the replay portion selection unit) will be described below with reference to FIG. 7.

Although FIG. 6 also shows a segmentation result acquired by integrating the segmentation results corresponding to the viewpoints PERSON and LOCATION, the integration segmentation result may not be provided as in the above-mentioned modification.

Referring to FIG. 7, the process of the replay portion selection unit 107 of FIG. 1 will be described. FIG. 7 is a flowchart illustrating a process example performed by the replay portion selection unit 107 in the first embodiment.

Firstly, the replay portion selection unit 107 receives, from the input unit 106, information indicating the topic segment selected by the user (step S701).

Subsequently, the replay portion selection unit 107 acquires, from the topic segmentation result database 103, TIMESTAMPs indicating the start and end times of each topic segment (step S702).

After that, the replay portion selection unit 107 integrates the start and end times of all topic segments, determines which portion(s) of the original video content should be replayed, and replays the determined portion(s) (step S703).

Assume here that in FIG. 6, the user has selected the second and third segments corresponding to the viewpoint PERSON, and the second segment corresponding to the viewpoint LOCATION. Assume further that the start times of the respective topic segments are the time 600 seconds after the start of the video content, the time 700 seconds after the same, and the time 1700 seconds after the same, while the end times are the time 700 seconds after the same, the time 2100 seconds after the same, and the time 2700 seconds after the same. In this case, it is sufficient if the replay portion selection unit 107 continuously replays the period of time ranging from the time 600 seconds after the start of the video content, to the time 2700 seconds after the same.

As described above, in the first embodiment, topic division is performed from a plurality of viewpoints corresponding to video content, and users can select any of the resultant topic segments. Thus, the users can be provided with a plurality of segmentation results corresponding to the viewpoints, and personalization that reflects the viewpoints of the users can be realized by causing them to select topic segments from the segmentation results corresponding to the viewpoints. Specifically, in a TV cooking program, the user may select a topic segment in which a particular performer appears, and a topic segment related to a particular dish. In contrast, in a TV travel program, the user may select only a topic segment related to a particular hot spring.

### Second Embodiment

The difference in configuration and function between a second embodiment and the first embodiment lies only in that the former includes a profile management unit. Therefore, in the second embodiment, the process performed by the profile management unit will be mainly described. Because of the provision of the profile management unit, the processes performed by the viewpoint determination unit and input unit slightly differ from those of the first embodiment.

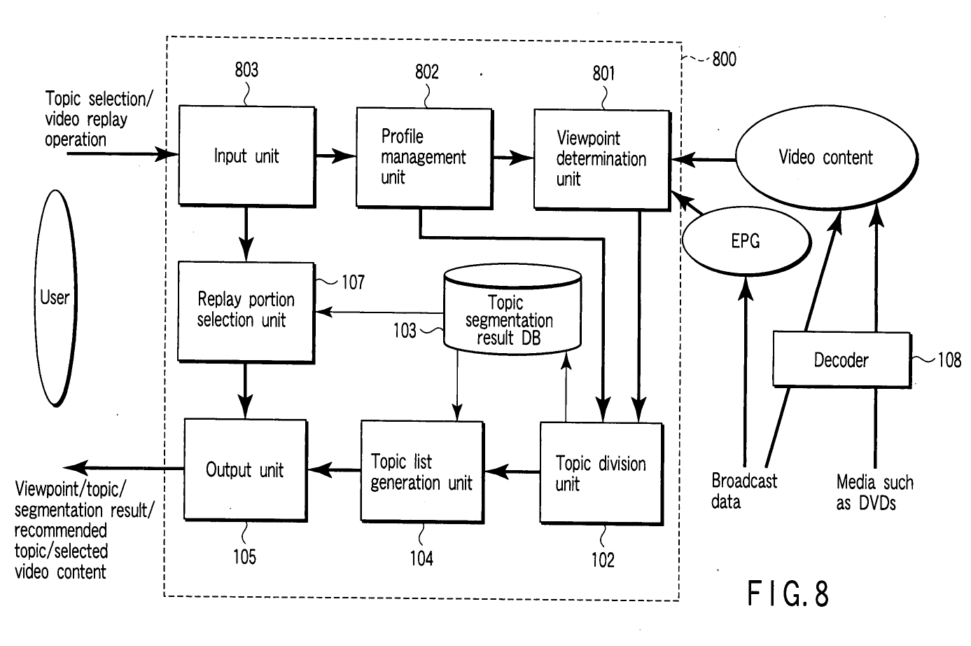

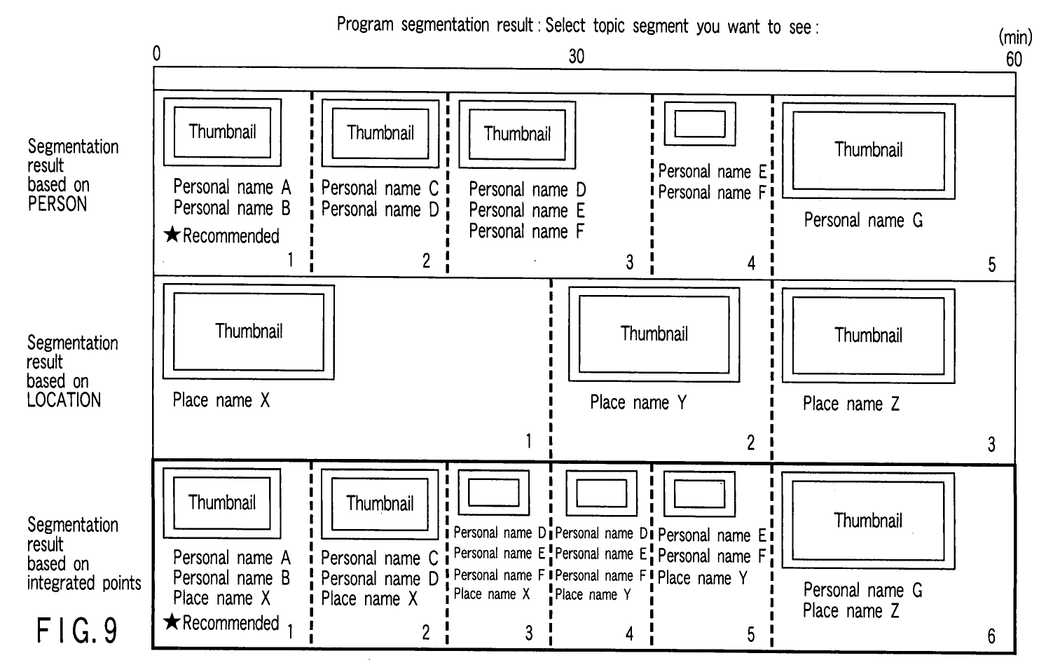

Referring to FIGS. 8 and 9, a video content viewing support system according to the second embodiment will be described. FIG. 8 is a schematic block diagram illustrating the video content viewing support system of the second embodiment. FIG. 9 is a view illustrating a topic list information example provided in the second embodiment.

A profile management unit 802 employed in the second embodiment holds, in a file called a user profile, a keyword indicating an interest of each user, and the weight assigned to the keyword. The initial value of each file may be written by the corresponding user through an input unit 803. For instance, if a user is fond of TV entertainers with names A and B, the keywords “Personal name A” and “Personal name B” corresponding to the entertainers and the weights assigned to the keywords are written in the user profile of the user. This enables recommended segments to be provided for users, as indicated by the sign “Recommended” in FIG. 9. In the example of FIG. 9, since some of the keywords contained in the first segment corresponding to the viewpoint PERSON are identical to the keywords held in the user profile, the first segment is provided for the user with the sign “Recommended”.

Note that the technique of providing for users of recommended information or information indicating the degree of interest is disclosed in, for example, JP-A 2004-23799(KOKAI), and is not the gist of the embodiment. The significant difference between the present embodiment and prior art is that in the present embodiment, relevance feedback information can be acquired from users in units of viewpoints. This will now be described in detail.

As shown in FIG. 7, the profile management unit 802 monitors user topic selection information input through the input unit 803, and modifies the user profile using the information. Assume, for example, that a user has selected the fourth topic segment corresponding to the viewpoint PERSON in FIG. 9. Since keywords “Personal name E” and “Personal name F” generated by the topic list generation unit 104 are contained in the fourth topic segment, the profile management unit 802 can add them to the user profile.

Further, assume that the user has selected the second topic segment corresponding to the viewpoint LOCATION. Since a keyword “Place name Y” is contained in the second topic segment, the profile management unit 802 can receive them from the input unit 803 and add them to the user profile. In contrast, in the prior art, since topic division is not performed in units of viewpoints, users are provided only with a single segmentation result apparently similar to the “Segmentation result based on integrated points” in FIG. 9. Further, in the-prior art, each topic segment contains a mixture of keywords, such as personal and place names. The fifth topic segment of the “Segmentation result based on integrated points” in FIG. 9, for example, contains three keywords “Personal name E”, “Personal name F” and “Place name Y”. On the other hand, in the prior art, since topic division is not performed in units of viewpoints, words related to unsorted viewpoints other than the above may well be used as keywords. Accordingly, in the prior art, when a user selects a topic segment, it is difficult to determine the reason why the user has selected it. Namely, when a user has selected a certain topic segment that contains, for example, the keywords “Personal name E”, “Personal name F” and “Place name Y”, it is difficult to determine whether they have selected the segment since they like the persons with the names E and F, or since they are interested in the place with the name Y.

In contrast, in the embodiment, topic segmentation results performed in units of viewpoints are provided for the user to permit them to select a topic segment. Therefore, user topic selection information can be acquired in units of viewpoints, which less requires modification of a user profile than in the prior art.

Furthermore, in the second embodiment, at least the viewpoint determination unit 801 or topic division unit 102 can modify the content of processing with reference to the user profile. For instance, if only words related to the viewpoints PERSON and FOOD are added to the user profile so far, which means that the user does not utilize the viewpoint LOCATION, the viewpoint determination unit 801 can perform the processing of beforehand providing the user with only the viewpoints PERSON and FOOD, and not with the viewpoint LOCATION.

Similarly, when in FIG. 9, the user has selected the second and third topic segments related to the viewpoint PERSON, it can be estimated that the user likes the person with the name D, therefore a keyword “Personal name D” may be newly added to the user profile, or the weight assigned to the keyword “Personal name D” may be increased and referred to for topic division performed later. In this case, the “Personal name D” may be regarded as important during later topic division, and the second and third topic segments be integrated into one topic segment.

As described above, in the embodiments, user topic segment selection information can be collected in units of viewpoints, which makes it easy to determine why the user has selected a certain topic segment, and hence facilitates appropriate modification of the user profile. This is very useful in providing the user with recommended information. In addition, the information fed back from the user can be used for modification of viewpoints to be provided for them, and for provision of topic division methods.

Although in the above embodiments, it is assumed that the closed captions are written in particular language, the embodiments are not limited to the language in which video content is written.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video content viewing support system comprising:
an acquisition unit configured to acquire video content and text data corresponding to the video content;
a viewpoint extraction unit configured to extract a plurality of viewpoints from the video content, based on the text data;
a topic extraction unit configured to extract, from the video content, a plurality of topics corresponding to the viewpoints, based on the text data;
a division unit configured to divide the video content into a plurality of content segments including first segments and second segments for each of the extracted topics, the first segments corresponding to a first viewpoint included in the viewpoints, the second segments corresponding to a second viewpoint included in the viewpoints;
a generation unit configured to generate a thumbnail and a keyword for each of the content segments;
a providing unit configured to provide the first segments and at least one of the thumbnail and the keyword corresponding to one of the first segments for each of the first segments; and
a selection unit configured to select at least one of the provided first segments.

2. The system according to claim 1, wherein the providing unit comprises a third extraction unit configured to extract, from the content segments, the second segments, and wherein the providing unit provides the second segments and at least one of the thumbnail and the keyword corresponding to one of the second segments for each of the second segments.

3. The system according to claim 2, wherein the providing unit provides the first segments, the second segments, at least one of the thumbnail and the keyword corresponding to the one of the first segments for the first segments, and at least one of the thumbnail and the keyword corresponding to the one of the second segments for the second segments.

4. The system according to claim 2, wherein the third extraction unit extracts the second segments, based on the keyword corresponding to the one of the second segments for each of the second segments.

5. The system according to claim 1, further comprising a third extraction unit configured to extract the second segments identical in time from the content segments corresponding to all the viewpoints, and the providing unit provides the second segments and at least one of the thumbnail and the keyword corresponding to one of the second segments for each of the second segments.

6. The system according to claim 5, wherein the providing unit provides the first segments, the second segments, at least one of the thumbnail and the keyword corresponding to the one of the first segments for the first segments, and at least one of the thumbnail and the keyword corresponding to the one of the second segments for the second segments.

7. The system according to claim 5, wherein the third extraction unit extracts the second segments, based on the keyword corresponding to the one of the second segments for each of the second segments.

8. The system according to claim 1, wherein the text data includes at least one of a closed caption contained in the video content corresponding to the text data, and an automatic recognition result corresponding to voice data contained in the video content.

9. The system according to claim 1, wherein the acquisition unit acquires, as the text data, at least one of a category indicting the video content and a word indicating the video content, and the viewpoint extraction unit extracts the viewpoints based on at least one of the category and the word.

10. The system according to claim 1, further comprising a storage unit configured to store a user profile indicating an interest of a user, and a modification unit configured to modify the user profile, based on the selected at least one of the first segment.

11. The system according to claim 10, wherein the topic extraction unit extracts the topics based on the user profile.

12. The system according to claim 10, wherein the viewpoint extraction unit extracts the viewpoints based on the user profile.

13. The system according to claim 1, wherein the viewpoints are named entity classes, and the topics are named entities.

14. A video content viewing support method comprising:
acquiring video content and text data corresponding to the video content;
extracting a plurality of viewpoints from the video content, based on the text data;
extracting, from the video content, a plurality of topics corresponding to the viewpoints, based on the text data;
dividing the video content into a plurality of content segments including first segments for each of the extracted topics, the first segments corresponding to a first viewpoint included in the viewpoints, the second segments corresponding to a second viewpoint included in the viewpoints;
generating a thumbnail and a keyword for each of the content segments;
providing the first segments and at least one of the thumbnail and the keyword corresponding to the one of the first segments for each of the first segments; and
selecting at least one of the provided first segments.
